(19) United States
(12) Patent Application Publication
(10) Pub. No.: US 2003/0097422 A1
(43) Pub. Date: May 22, 2003

(54) System and method for provisioning software

(76) Inventors: Dave Richards, Toronto (CA); Robert Reive, Georgetown (CA); Mark Verdun, Toronto (CA); Bruno Baloi, Toronto (CA); Simon Howard, Toronto (CA)

Correspondence Address: STIKEMAN ELLIOTT, Barristers & Solicitors, Suite 1600, 50 O'Connor Street, Ottawa, K1P 6L2, CA

(21) Appl. No.: 10/180,010

(22) Filed: Jun. 26, 2002

(30) Foreign Application Priority Data
Nov. 21, 2001 (CA) 2,363,411

(51) Int. Cl. G06F 15/16

(52) U.S. Cl. 709/217

(57) ABSTRACT

A system and method for provisioning software. A managed hardware device connected to a network is discovered in response to a service order created on a remote server. A service agent and software container is sent from the server to the device. Software in the container is started up and the device is monitored and managed from the server.

### FIELD OF THE INVENTION

The present invention relates to the fields of software provisioning and computer hardware management. More particularly, the present invention relates to the automatic distribution, installation, and monitoring of operating systems and application software on computers linked to a network from a remote location.

### BACKGROUND OF THE INVENTION

Computer systems are often characterized by a main computer including hardware such as RAM, ROM, memory, and peripheral devices such as keyboards, pointing, monitors, printers and audio or visual input/output devices. Typically, the main computer must be programmed with operating system software that guides and controls the basic function of the computer and provides the necessary link between hardware and the various application programs.

Conventional methods of installing operating system software on a computer system rely upon a user to either (1) manually install the operating system from CD ROM or floppy disk, or (2) using image files to copy an operating system installation from one computer system to another. Such installation methods, however cannot be done from a remote location and are therefore not well suited for Internet-based enterprises such as Independent Software Vendors (ISVs) or Service Providers. Furthermore, manually installing software from CD ROM is very time consuming, requires a help desk professional to physically visit each computer and can create non-standard installations, especially if customization is required in addition to the basic installation. With non-standard installations, parameters can be erroneously set or missed. Manual installation also requires experts in each software package, cannot be done over the Internet and is very expensive. Using image files to copy an installation requires both the transferor and transferee hardware to be exactly the same (including disk drive, monitor, and Network card), and once installed, the copied system is not easily upgraded, making it very inflexible. Furthermore, such an installation cannot be performed over a network.

Software installation methods have been developed whereby application software can be downloaded by a user from a server via the Internet using a web-browser and then installed on the user's computer. However, these methods are initiated by the transferee and do not support a centralized means of applications management. Secondly, while such installation methods are useful for the installation of application programs, it is not possible to install a computer operating system using these methods.

Thus, there is a need for a system and method by which the installation of software is standardized such that an appropriate operating system and application programs can be automatically installed, and managed on a computer system. It is further desirable that such auto installation and management can be performed from a remote location over a network, subnet, or the internet with less highly skilled technical support being needed than with conventional installation methods.

### SUMMARY OF THE INVENTION

Accordingly, the invention relates to a method of remotely provisioning a managed hardware device connected to a network and having a hard drive, comprising: on a remote server connected to the network, creating a service order defining provisioning requirements of said device; discovering said device from said server; sending a service robot to the device from said server; sending a software container to the device from said server; starting up software in said container; and monitoring the device from said server.

In another aspect, the invention relates to an apparatus remotely provisioning a managed hardware device connected to a network and having a hard drive, comprising: a provisioning server including an application server, a pre-execution boot server, a file transfer server, an IP address server, an application warehouse server and a workflow server; a client hardware linked to said provisioning server; an operations center application server; and a GUI for accessing said servers.

### BRIEF DESCRIPTION OF THE DRAWINGS

The invention is described in greater detail with reference to the accompanying drawings, which illustrate a preferred embodiment of the invention and wherein:

FIG. 1 is a diagrammatic representation of an exemplary network within which the present invention may be implemented;

FIG. 2 is a diagrammatic representation of an operations center according to the invention;

FIG. 3 is a flow chart illustrating a method according to one embodiment of the present invention;

FIGS. 4 to 9 are print screens of service order screens which form part of a GUI according to the present invention;

FIGS. 10 to 12 are print screens of service order deployment screens according to the present invention; and

FIG. 13 is a print screen of an alerts and events logs screen according to the present invention.

### DETAILED DESCRIPTION OF THE PREFERRED EMBODIMENT

The following definitions are used herein:

DHCP: Dynamic Host Configuration Protocol

It provides a mechanism for allocating IP addresses dynamically so that addresses can be reused when hosts no longer need them.

GUID: Globally Unique Identifier

The GUID is present in client computers that are PC98- or Net PC-complaint and is found in the system BIOS of the computer. The GUID serves as a unique identifier for each and every platform on the network.

PXE: Pre-boot eXecution Environment

Technology that allows the PC98-complaint computers to boot from the remote boot server.

In the preferred embodiment, the present invention is included in a system known as Platespin Operations Support System (“Platespin OSS™”). The present invention provides a system and method for automating the discovery of new hardware after connection to a network and the remote installation (provisioning) of operating system software and required application software on the new hardware and monitoring. The new hardware is also referred to herein as the managed hardware which can include a server to be configured. In a preferred embodiment of the present invention, the operations of the new hardware and installed software are monitored and managed from a remote location and the network is controlled in terms of moving or duplicating operating systems and applications for performance reasons.

The general system configuration of the present invention discloses one possible implementation of the present invention for the automated installation of software from a remote location onto hardware connected to the Internet. Aspects of Platespin OSS™ include:

Automated Installation of operating systems and application software;

Distributed Service Control with XML to communicate between hardware servers and managed hardware;

Containerized distribution of operating system and server application bundles and business services (collections of applications) that can be easily moved throughout the Internet, upgraded, backed-up or deleted;

Remote discovery of hardware servers that are connected to the Internet including: automated detection within the subnet or controlled area (within DHCP Proxy area) and bootable media detection in the Internet space;

Integrated security including SSL for transactions, encrypted containers using DES keys for the applications provisioned, and connections to public key provider companies such as Entrust for PKI control for users and menu options;

A workflow engine to automate, manage and streamline the provisioning process by showing the status of operations as performed; and

A suite of agents and robots to remotely install an operating system and application software. The invention is preferably embodied in Java™ in order to be portable to all platforms supporting Java™.

A transaction based system is included for all installation requests, deployments, movements, updates and adjustments. The system includes an asset management data tracking facility for all software operating on each managed hardware server. The system includes a multi dimensional view into the software in isolation or combination with any of the following views: by Internet Protocol, by geographic location, by service framework (messaging, hosting, e-commerce, etc), by existing services to customers, by utility, or by managed hardware type.

The system is preferably programmed in Java™ for platform independence and scalable to meet client/customers requirements. Scalability is made possible by a database for transactions and application servers. The database contains requirements, work orders, software services, managed hardware details, applications, the network organization, geographic information of server locations and all transactions regarding the provisioning of software applications.

The system uses a component architecture. Each component of the system can be deployed on single or multiple hardware servers. The system is extensible and uses XML structures in its Distributed Service Control systems to communicate between hardware servers and to connect with other applications such as e-procurement systems, ticketing systems, e-billing systems, quality of service systems, or accounting systems.

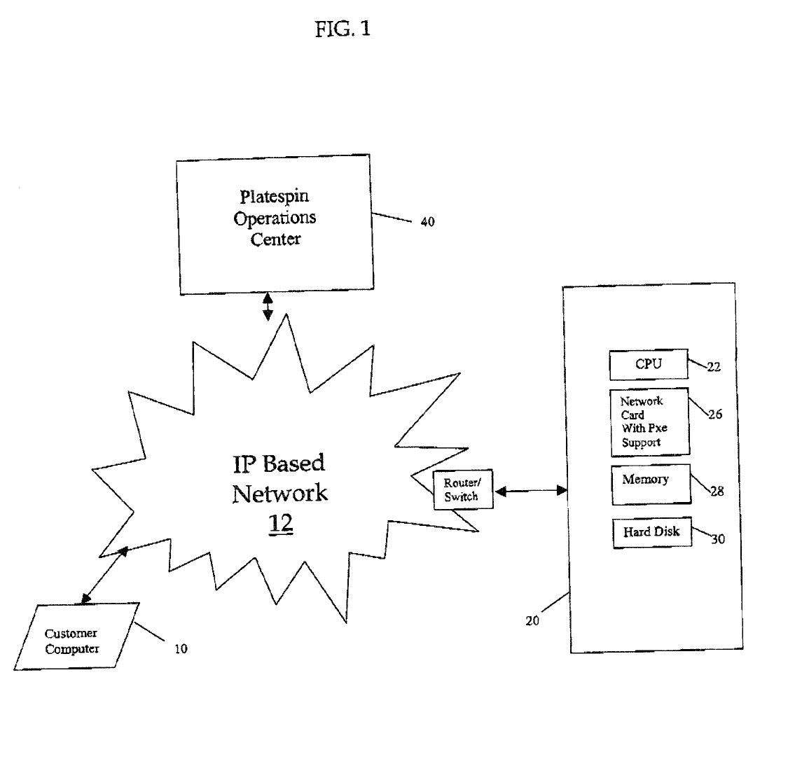

FIG. 1 is a schematic diagram representing a computer 10 (a customer computer) which is connected to the Internet 12 and has already been configured in terms of an operating system and application software computer 20 is a managed hardware server which has not been configured. The server 20 includes a processor 22, I/O interface 24, network interface 26, memory 28, and hard disk 30. All of the components with appropriate adapter components are connected in a conventional manner via a common bus. It will be appreciated that other configurations are possible.

The Platespin Operations Center 40 represents the structure of a central management system connected to the Internet. The system provides the basis for enabling centralized and standardized automated installation and management of operating systems and application programs over the Internet 12.

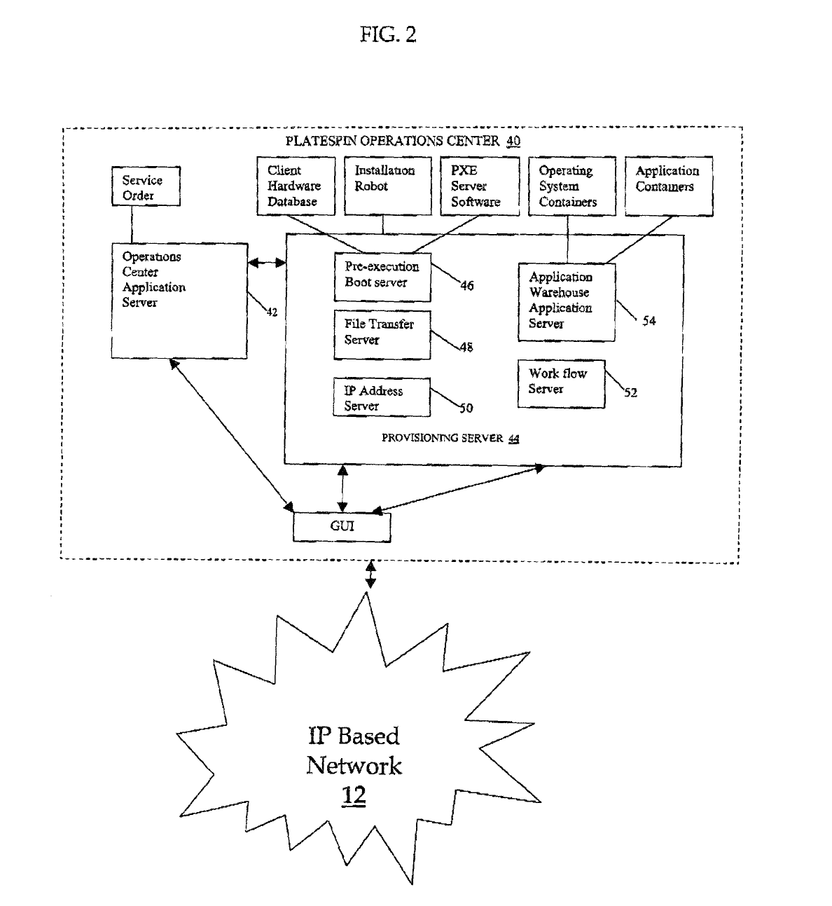

FIG. 2 is a schematic representation of one possible configuration of the center 40 having an application server 42, and a provisioning server 44. The provisioning server is a combination of a pre-execution boot sever 46, a file transfer sever 48, an IP addressing server 50, a workflow server 52, and an application server 54.

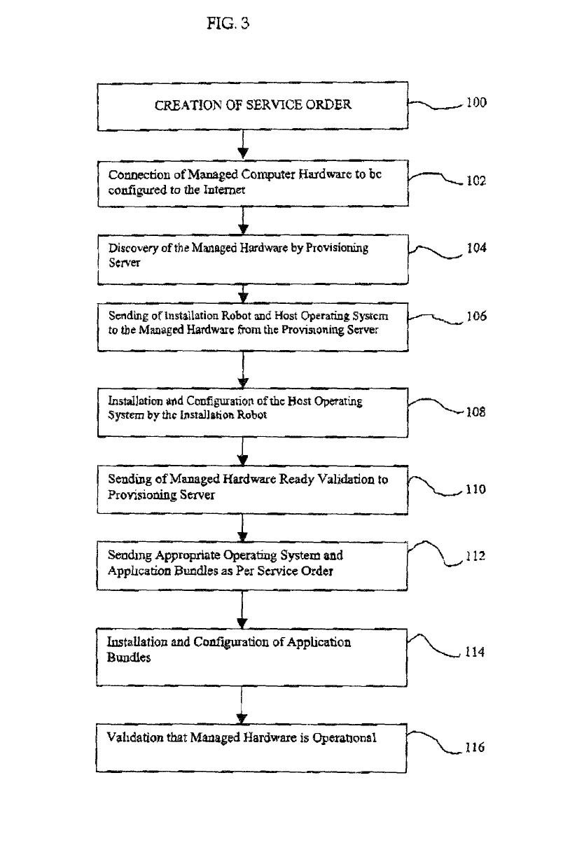

FIG. 3 is a flow diagram giving an overview of the process for the configuration of a managed hardware server. The initiation of the process is caused at step 100 by the creation of a service order in response to a customer accessing the “Platespin Operations Center” Java™ application from a customer computer 10 using a web browser (as least Netscape 4.7 or Internet Explorer 5) to create a service order. The provisioning process is controlled through General User Interface (GUI) and a Java™ application which is automatically installed upon accessing the Operations Center. The Java™ application checks for updates and provides the benefits of zero maintenance with the power of a Java™ application. The service order defines the requirements of the managed hardware server 20 on which software is to be installed in a manner that supports a customer, division or the infrastructure for future requirements. The service order also tracks the deployment of operating systems and software applications using a workflow sensor.

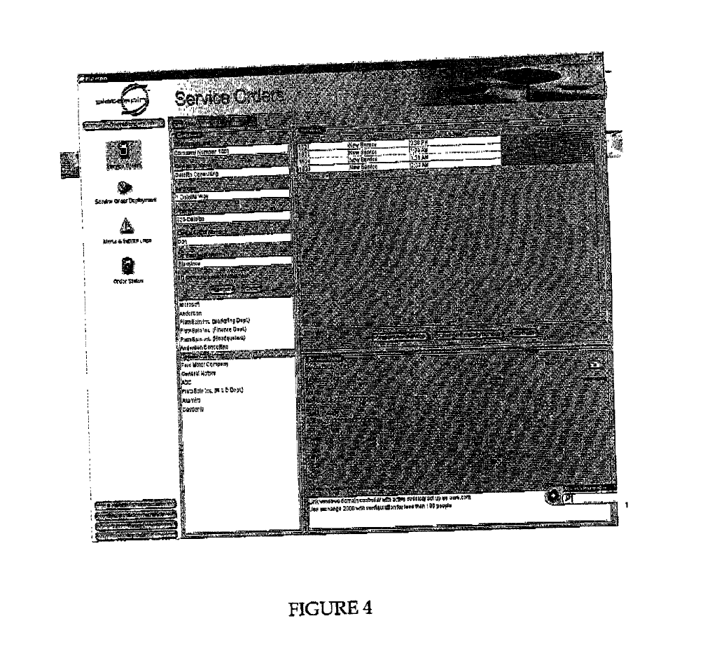

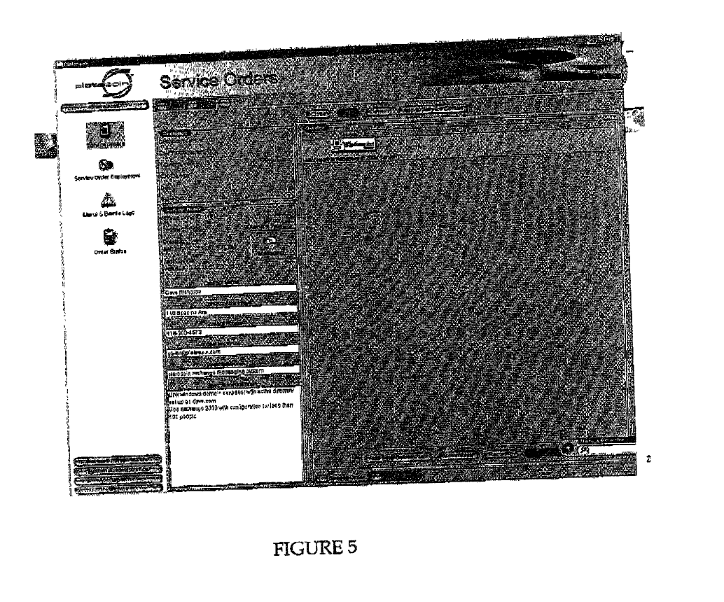

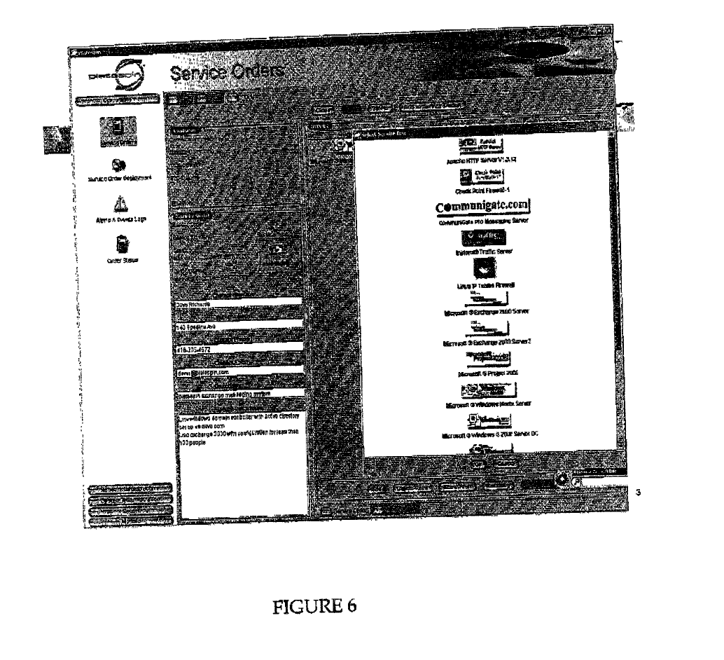

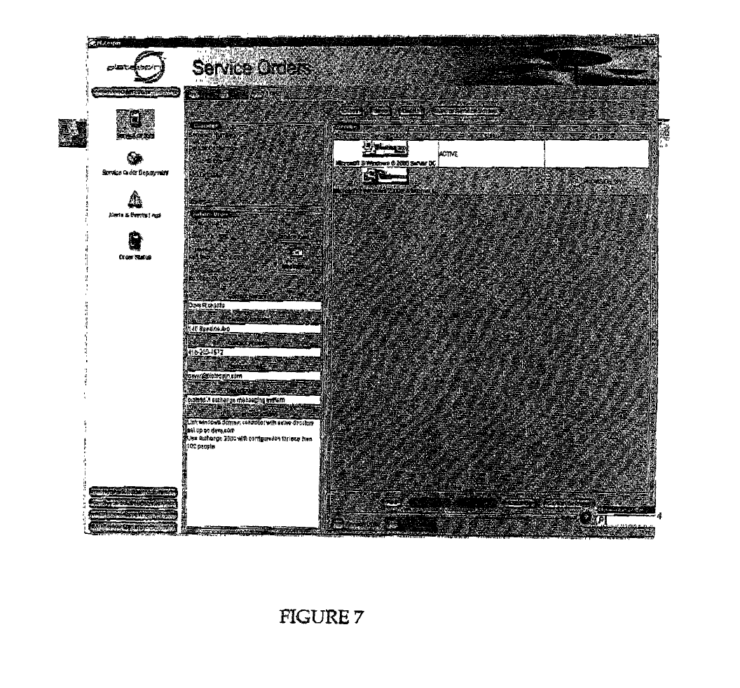

FIGS. 4 to 7, are print screen pages of Service Order screens which form part of the GUI. The screens provide for the selecting of operating system and application software to be provisioned from an on-line catalogue, confirmation of the required workflow (from a standard), then entry of specific information required for each customer/application combination.

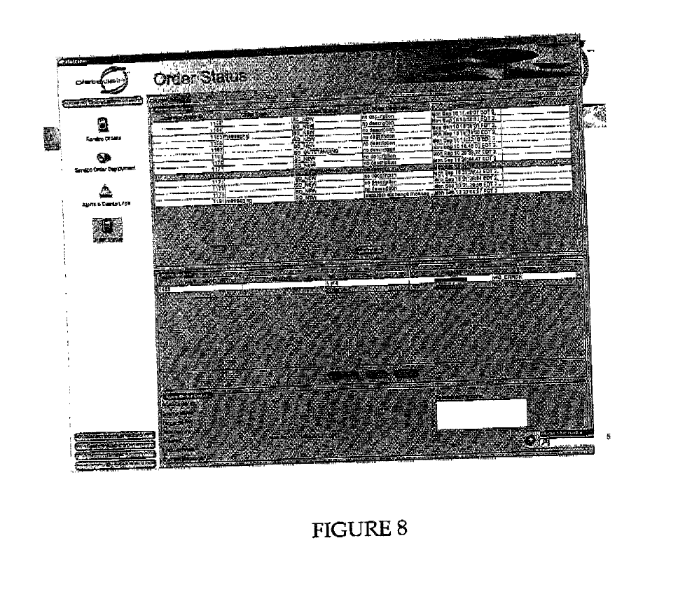

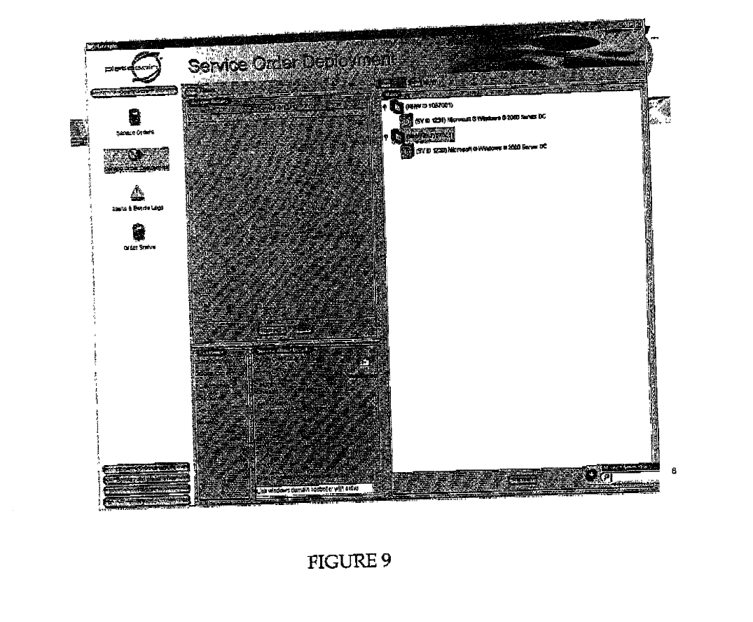

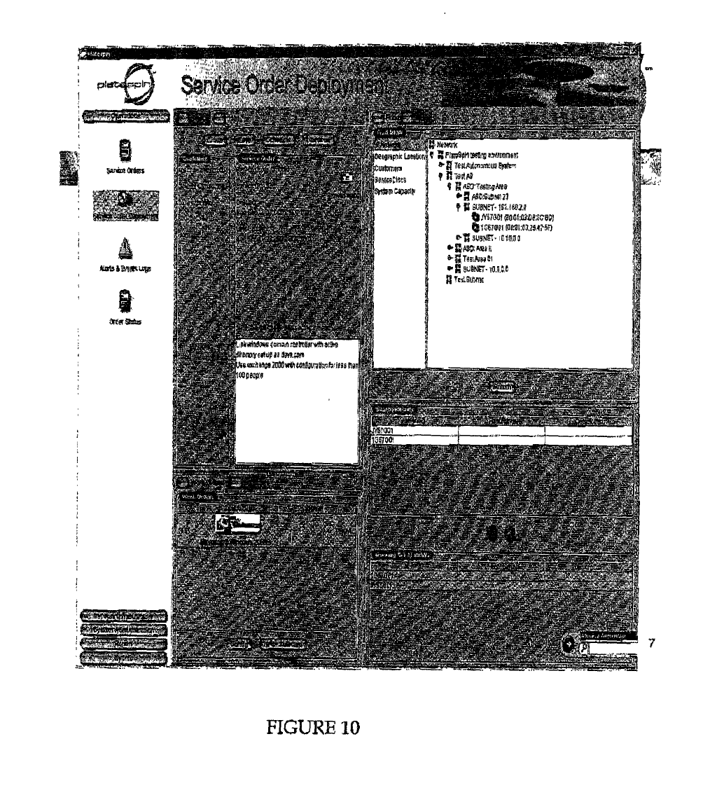

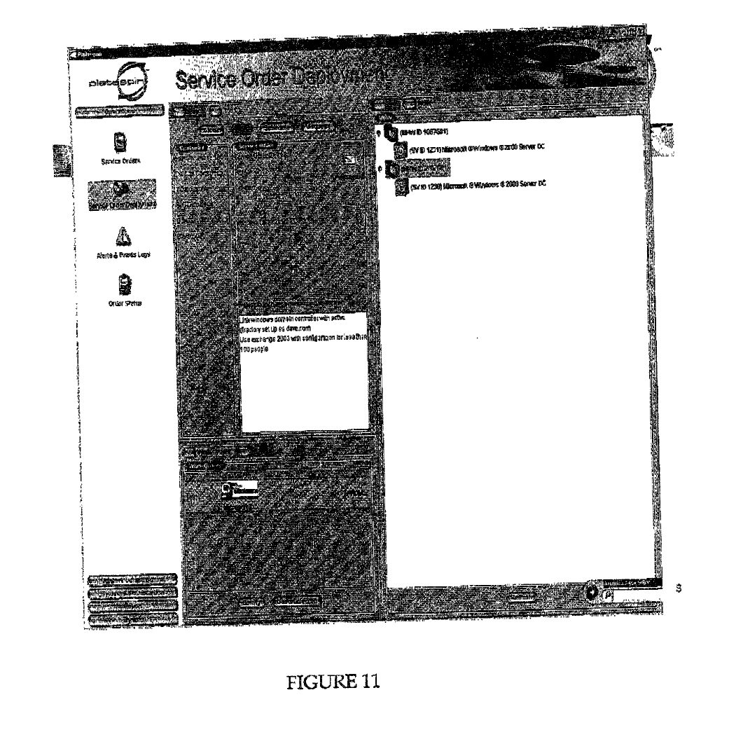

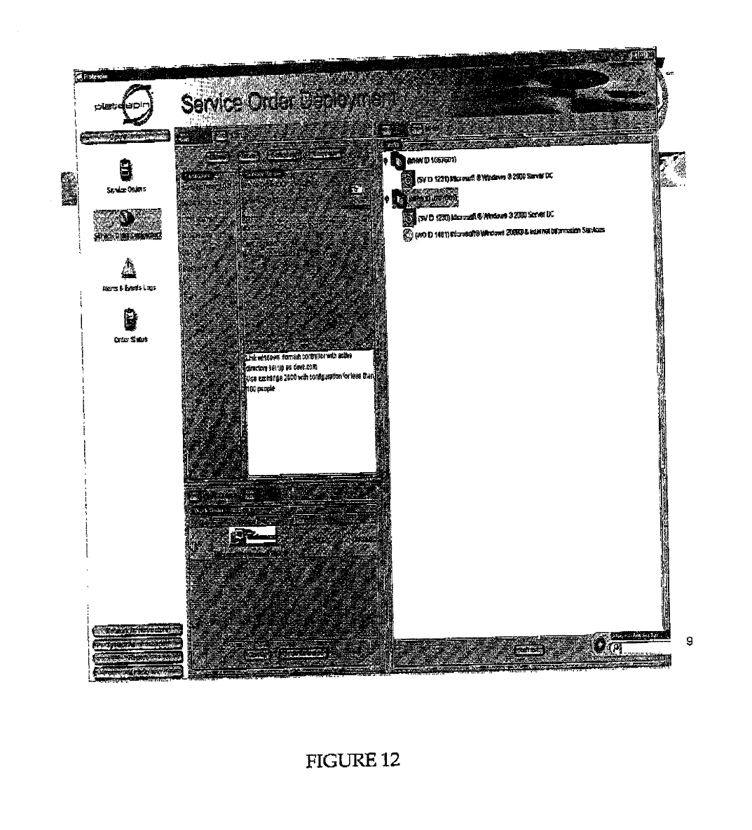

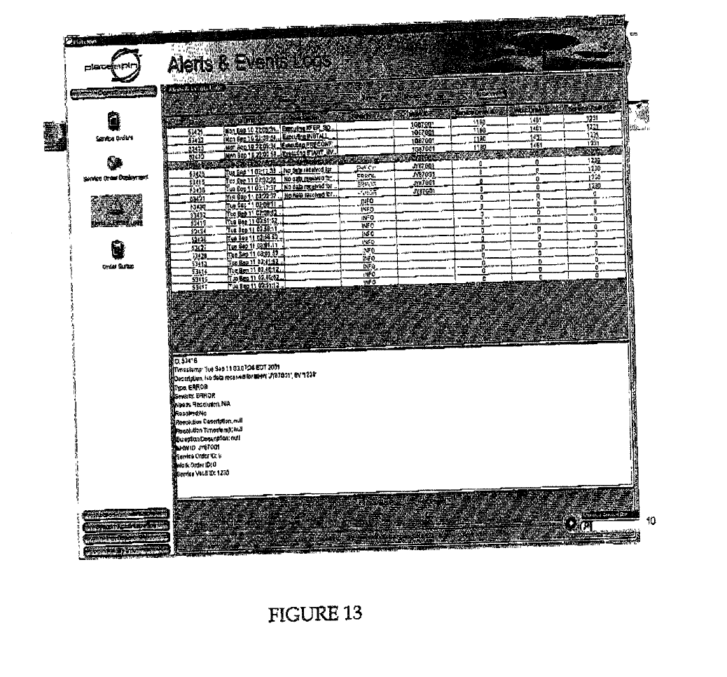

Referring to FIGS. 8 to 12, the Service Order is then provisioned by selecting the service order and any of the six resource locator views to deploy to including:

The IP including the autonomous system, area, subnet or VLAN;

The geographical location including the country, city, datacenter, floor, row, rack and shelf;

The business service framework of similar services already operational ready for new customers to be added;

Utilities such as a Domain Name Service, DHCP server, Firewall, or Virus Checker

The customer business service if the exiting managed hardware servers are required and another service on top; or

The application server farm based on the management hardware servers already running the required applications.

Deployment of operating systems and software applications are done through a drag and drop metaphor by selecting the icon of the software service (operating system and application(s)) and dragging it on to the managed hardware server. Then a dialog box is displayed to allow entry of any user specifics to be set for the service for its customer configuration.

The customer configuration is categorized into three areas:

Internet Protocol (IP) data including the Host names, IP address, gateway, DNS, and DHCP

Licensing information including the application and required keys to use the applications

Application specific information including the configuration and set up information for specific customer instances.

The provisioning process and can proceed immediately if the managed hardware is available, or will wait until the appropriate managed hardware is discovered and is available.

### DISCOVERY PROCESS

In step 102, independent of the service order, the managed hardware server 20 with PXE support 26 is connected to the Internet 12 then started up. Each server turned on is available for server-based applications provisioned by the system. The system has the capability to define a Service Provider's Infrastructure Network (SPIN) that defines the autonomous systems, areas, subnets, VLANs as well as geographical information from the country, city, data center, floor, row, rack and shelf. These definitions allow the invention to either include or exclude discovered hardware from being included in the automated provisioning process by the provisioning server 44.

The Platespin OSS™ system uses remote boot technology and in particular, Pre-Boot eXecution Environment (PXE). PXE provides companies with the ability to use their existing TCP/IP network infrastructure with the Dynamic Host Configuration Protocol (DHCP) to discover remote boot servers on the network. Net PC/PC98-compliant systems, and computers equipped with network interface cards (NICs) support the PXE-based remote-boot technology. A client computer that is PC-98- or NET PC-compliant can be identified with its Globally Unique Identifier (GUID) of its NIC, which is found in the system BIOS of the computer.

When a PXE-enabled client computer is turned on, the PXE-based ROM requests an IP address rom a DHCP server using the normal DHCP discovery process. As part of the initial DHCP discover request, the client computer identifies itself as being PXE-enabled, which indicates to the remote boot servers on the network that it is looking to be serviced. The remote boot server on the network can respond by providing the client with its IP address, and the name of a boot file the client should request. Thus the “Provisioning server” along with the PXE server software will discover the managed hardware starting up.

Platespin OSS™ uses the new PXE DHCP-based remote boot technology to initiate the installation of software from a remote source to a client hard disk. The PXE technology provides a basis for remote installation service.

In step 104, the provisioning server 44 along with the PXE server software discover the managed hardware 20 starting up, look up the IP and MAC information in the client hardware database and determine if this is a new hardware, or an already provisioned server rebooting. After the PXE-enable Managed Hardware is turned on, it requests an IP address from a DHCP server and indicates to the remote boot server that it is looking to be serviced. The provisioning server sends its IP address and the name of a boot file to this computer, after matching the computer's IP address and GUID with those in the service order. After the provisioning server discovers the hardware, the server checks the IP address and GUID of the computer in the client database, and determines whether this computer is a new hardware. If the managed hardware is found in the database, the provisioning server 44 allows the managed hardware server to continue booting.

If the managed hardware is not found in the database, the following process is followed:

In step 106, the provisioning server 44 sends on installation robot to the managed hardware server using TFTP The installation robot then partitions and formats the hard disk drives. In step 108, the installation robot transfers, installs and configures the host operating system with the container management system and managed hardware agents to monitor the managed hardware.

In step 110, the installation robot sends a validation message to the provisioning server 44 that the managed hardware 20 is then ready for the provisioning of ServiceDisc™. The ServiceDisc™ includes the managed hardware operating system, application software and agent bundle.

### SERVICEDISC™ PROVISIONING PROCESS

In step 112, the provisioning server 44 and robot then transfer the ServiceDisc™ using either TFTP or MTFTP as per the service order. If a service order is created for a single drag and drop operation, then only TFTP is required. If an update to a group of servers is required, then MTFTP is used to multicast the file transfer and update all the computers from a single image instead of serially deploying each managed hardware server.

In step 114, the installation robot then unpacks installs and configures the operating system, containerization programs and monitoring components. The Service is then unpacked at the managed hardware service and prepared for configuration. Then the service is configured including the customer configuration information defined in the service order Management section. The operating system and application are then started. Then automatic script files and setup files passed to the ServiceDisc™ are run for the final instrumentation scripts to fulfil the application organization, integration and final installation specific information requirements. The monitoring robot is turned on and reports heartbeat information on the status of the new business service.

The unpacking, installation and configuration steps, as well as the other provisioning workflow processes, is completely automated and requires no user intervention unless problems occur. If any problem is detected, a message is sent to the Alert and Event Log along with an audible message. The Host Operating system installation can be seen on the managed hardware server as a monitor and video card are connected to the managed hardware server.

The Installation Robot then applies the security rules to decrypt the ServiceDisc™. Then an application specific installation robot does the final configuration to get the business service up and operational.

In step 116, the Installation robot validates that the managed hardware 20 is up and operational, and sends the “Active” message back to the PLATESPIN Operations Center work flow server 52 that updates the database, event log, and online status bars.

The “Managed Hardware Server” validation is sent after the operating system is started, up and operational. This validation message is again sent to the Alert and Event Log with an audible message also being sent

The PLATESPIN Operations Center can then send an acknowledgement defined in the workflow.

### CONTAINERIZATION

Platespin software includes software components in the host operating system that enable multiple bundles of operating systems, applications and Platespin agents (ServiceDisc™) to operate concurrently on a managed hardware server. The operating systems include server based version of Microsoft Windows NT™, Microsoft Windows 2000™, Linux™ and Solaris™. The application programs include any application that will run in the above operating systems. For example, this will enable the Windows 2000™ server and an application such as Exchange 2000 to operate concurrently with a Linux™ operating system and the Apache Web hosting application software.

These complete environments of operating systems and applications are bundled in a software container that allows transporting throughout the network and Internet.

These containers run applications that have been set up, configured, and pre-populated with the essential information to be operational from the first minute of provisioning. Whereas standard installation programs install applications to a base minimum, PLATESPIN ServiceDisc™ containers can be configured to meet specific customer requirements before standardization and the provisioning process.

The ServiceDisc™ are built using a virtual machine technology that has abstracted the specific device drivers so that all applications are not bound directly to the hardware. This feature allows portable ServiceDisc™ that can be transported throughout the network and Internet, and run on different hardware.

Whereas standard installation and software imaging processes require either a specific installation to each managed hardware, or hardware that is exactly the same, PLATESPIN's containerized ServiceDisc™ allow flexibility to move operating systems and application throughout the network and Internet.

### WORK FLOW ENGINE

The Platespin Work Flow engine manages the provisioning process, provides status feed back as to the stage of the individual ServiceDisc™ provisioning process, and provides alerts or inputs to the event logs.

The workflow engine manages the provisioning of the Service Robot, ServiceDisc™s and Startup of application services:

1. The Service Robot Provisioning includes the following steps:

a. Send the installation robot to the managed hardware;

b. Partition and format the hard disk drive(s) of the managed hardware;

c. Transfer and install the host operating system on the managed hardware;

d. Start the Managed hardware agents; and

e. Update the status to all relevant users

1. The ServiceDisc™ Provisioning includes the following steps:

a. Transfer ServiceDisc™s to the managed hardware;

b. Decrypt the ServiceDisc™s;

c. Unpack and install the operating system, containerization programs and monitoring components;

d. Run the configuration scripts for each application; and

e. Update the status to all relevant users

3. The Start-up of Application Services includes the following steps:

a. Start the Application in the virtual machine container; and

b. Update the status to all relevant users

Start-up of Monitoring

### ASSET MANAGEMENT FACILITY

The asset management and facility is based on the information stored in the Platespin database and reported though the reporting server. The asset management information is grouped into four areas including the location of managed hardware, the managed hardware details, and applications running on each managed hardware, and the current service provided to divisions or customers.

More specifically, the main tables in these four areas include:

1. Location information:

a. Country, city, street, data-center

b. Floor, row, rack, shelf

2. Managed hardware details

a. CPU

b. Disk drives—number, capacity per disk, availability

c. Nic cards—number, speed, mac

d. Ram memory—amount and availability

e. TCP/IP information

3. Current services provided to divisions or customers

a. Current applications and managed hardware they are running on to support customers/divisions

b. Status of services

4. Applications running on each managed hardware

a. Software applications running on managed hardware including application name and version

b. Base created from

c. Specific driver and DLL upgrade information

### INSTALLATION ROBOTS

The installation robots are C and C++ applications that are moved into random access memory and run to quickly control and instruct the managed hardware through its provisioning process. PLATESPIN software defines specific installation robots are for each platform including Intel 32 bit computers, Intel 64 bit computers and Sun Sparc systems. The installation robots read XML based messages sent using the Distributed Service Control Language and Protocol, and perform the necessary tasks on the remotely managed hardware.

The installation robot tasks include:

1. Check if managed hardware is in the database

2. Partition and format the hard disks

3. Initialize the portal

4. Transfer ServiceDisc™s

5. Inform that the platform is ready

### DISTRIBUTED SERVICE CONTROL

The Distributed Service Control system is the XML based language and protocol for the PLATESPIN Portal to send messages, control and provision software applications throughout the network and Internet.

The Distributed Service Control Language is grouped into eight areas with the specific messages including:

1. Managed Hardware Bootup

a. Portal Initialization

b. Return Context—IP and configuration of all Platetspin servers

c. Managed hardware heartbeat information—status.xml, utilization

d. Managed Hardware “Ready”

2. Provision Host Operating System

a. Send Host Operating System

b. Initiate Host Operating System Provisioning

c. Return Context and PXE information

d. Managed hardware heartbeat information—status.xml

e. Managed Hardware “Ready”

3. ServiceDisc™ Provisioning

a. Send ServiceDisc™ to managed hardware

b. Initiate ServiceDisc™ provisioning

c. Return Context IP and application information

d. Managed hardware heartbeat information—status.xml, utilization

4. ServiceDisc™ Shutdown

a. Shutdown running operating system and applications

b. Update database and status in PLATESPIN Operations Center for specific users registered for dynamic updates

5. ServiceDisc™ Delete

a. Delete running operating system and applications

b. Update database and status in PLATESPIN Operations Center for specific users registered for dynamic updates

6. ServiceDisc™ Startup

a. Startup operating system and applications

b. Update database and status in PLATESPIN Operations Center for specific users registered for dynamic updates

7. ServiceDisc™ Reset

a. Reset database and status in PLATESPIN Operations Center for specific users registered for dynamic updates

8. Monitoring

a. Send detailed information to the monitoring system then to specific users registered for updates. Data includes managed hardware components

b. Send detailed statistics of real-time performance to the monitoring system then to specific users registered for updates. Data includes CPU utilization, memory usage, disk drive availability, information sent via the network.

c. Message to subscribe to the monitoring system to receive updated heartbeat statistics and detailed information

d. Message to un-subscribe and not receive constant heartbeat updates

We claim:

1. A method of remotely provisioning a managed hardware device connected to a network and having a hard drive, comprising:
on a remote server connected to the network, creating a service order defining provisioning requirements of said device;
discovering said device from said server;
sending a service robot to the device from said server;
sending a software container to the device from said server;
starting up software in said container; and
monitoring the device from said server.

2. A method according to claim 1, wherein said software container includes a host operating system, application software, a container monitoring system and managed device agents.

3. A method according to claim 2, including:
said robot partitioning and formatting the hard drive;
said robot transferring, unpacking and installing said host operating system, said container monitoring system and said managed device agents to the device;
said robot starting said managed device agents; and
said robot updating the status of said device.

4. A method according to 3, including:
decrypting said container; and
running configuration scripts for said application software.

5. A method according to claim 4, wherein said device is a Service Provider's server.

6. A method of remotely provisioning a managed hardware device connectable to a network and having a hard drive, comprising:
creating a service order;
connecting said device to a network;
discovery of said device by a provisioning server connected to the network;
sending an installation robot and host operating system to said device from said provisioning server;
said installation robot installing and configuring said operating system;
sending a managed device ready validation from said device to said provisioning server;
sending a software bundle to said device in accordance with said service order;
installing and configuring said bundle on said device; and
validating that said device is operational.

7. An apparatus for remotely provisioning a managed hardware device connected to a network and having a hard drive, comprising:
a provisioning server including an application server, a pre-execution boot server, a file transfer server, an IP address server, an application warehouse server and a workflow server;
a client hardware linked to said provisioning server;
an operations center application server; and
a GUI for accessing said servers.

8. An apparatus according to claim 7, wherein said provisioning server includes a client hardware database and PXE software.

9. An apparatus according to claim 8, wherein said application warehouse server includes an operating system container and an application container.
